(19) United States
(12) Patent Application Publication
(10) Pub. No.: US 2006/0155894 A1
(43) Pub. Date: Jul. 13, 2006

(54) Asynchronous messaging in storage area network

(76) Inventor: Aidan Charles Pennington, Sakura The Green Elstead Godaiming (GB)

Correspondence Address: LIEBERMAN & BRANDSDORFER, LLC, 802 STILL CREEK LANE, GAITHERSBURG, MD, 20878, US

(21) Appl. No.: 10/522,136

(22) PCT Filed: Jul. 11, 2003
(86) PCT No.: PCT/GB03/03032

§ 371 Date: Aug. 16, 2005

(30) Foreign Application Priority Data
Jul. 24, 2002 (GB) 0217088.4

(51) Int. Cl. G06F 5/00

(52) U.S. Cl. 710/52

(57) ABSTRACT

A computer system includes an asynchronous messaging-and-queuing system; and a storage area network having a storage area network controller in communication with the asynchronous messaging-and-queuing system. The storage area network controller includes control means to control a message queue on behalf of one or more queue managers, which may be heterogeneous. The storage area network controller may also include means for controlling persistence of messages, transactional control means, such as a syncpoint coordinator, and data integrity control means, such as a lock manager.

### BACKGROUND OF THE INVENTION

1. Technical Field

This invention relates to systems for asynchronous messaging-and-queuing, and more particularly for the control of storage of messages.

2. Description of the Prior Art

Asynchronous messaging-and-queuing systems are well known in the art. One such is the IBM® MQSeries® messaging-and-queuing product. (IBM and MQSeries are registered trade marks of IBM Corporation.) An MQSeries system is used in the following description, for convenience, but it will be clear to one skilled in the art that the background to the present invention comprises many other messaging-and-queuing systems.

In an MQSeries message queuing system, a system program known as a “queue manager” provides message queuing services to a group of applications which use the queue manager to send and receive messages over a network. A number of queue managers may be provided in the network, each servicing one or more applications local to that queue manager. A message sent from one application to another is stored in a message queue maintained by the queue manager local to the receiving application until the receiving application is ready to retrieve it. Applications can retrieve messages from queues maintained by their local queue manager, and can, via the intermediary of their local queue manager, put messages on queues maintained by queue managers throughout the network. An application communicates with its local queue manager via an interface known as the MQI (Message Queue Interface). This defines a set of requests, or “calls”, that an application uses to invoke the services of the queue manager. In accordance with the MQI, an application first requests the resources which will be required for performance of a service, and, having received those resources from the queue manager, the application then requests performance of the service specifying the resources to be used. In particular, to invoke any queue manager service, an application first requires a connection to the queue manager. Thus the application first issues a call requesting a connection with the queue manager, and, in response to this call, the queue manager returns a connection handle identifying the connection to be used by the application. The application will then pass this connection handle as an input parameter when making other calls for the duration of the connection. The application also requires an object handle for each object, such as a queue, to be used in performance of the required service. Thus, the application will submit one or more calls requesting object handles for each object to be used, and appropriate object handles will be dispensed by the queue manager. All object handles supplied by the queue manager are associated with a particular connection handle, a given object handle being supplied for use by a particular connection, and hence for use together with the associated connection handle. After receiving the resources to be used, the application can issue a service request call requesting performance of a service. This call will include the connection handle and the object handle for each object to be used. In the case of retrieving a message from a queue for example, the application issues a “get message” call including its connection handle and the appropriate queue handle dispensed to the application to identify the connection and queue to the queue manager.

With asynchronous messaging systems available today, when a message arrives at a server it is only available to that server. In the event of failure of that server, the message is “trapped” in the server until the server can be restarted. For example, in high capacity or high performance application architectures the storage of messages in individual servers is a limitation. The individual server has to determine that the intended destination server is able to handle the message and any subsequent processing required in a timely manner. Typically, this determination has to be made by the server before a message is sent. Accordingly, there are limitations associated with prior art asynchronous messaging systems.

Therefore, there is a need for a more robust and flexible method and system for storage of asynchronous messages in such systems. Preferably, such a method and system will centralize storage and processing of messages to eliminate shortcomings associated with failure of servers and messages stored therein.

### SUMMARY OF THE INVENTION

This invention comprises an asynchronous messaging-and-queuing system in communication with a storage area network to mitigate loss of messages among servers in communication with the storage area network.

In one aspect of the invention, a computer system is provided with an asynchronous message and queue system and a storage area network controller in communication with the asynchronous message and queue system to control a queue held in a storage area network. The storage area network controller is provided with control means to control a message queue on behalf of a queue manager. In addition, the storage area network controller controls a transactional or persistent message.

In another aspect of the invention, a method is provided for communicating in a computer system. A queue in a storage area network of the computer system is managed to support an asynchronous messaging and queuing system. A message request is received at a queue manager of the storage area network. The message request is passed to a storage area network controller of the storage area network, wherein the controller controls has means to control a message that may be in the form of a transactional message or a persistent message.

In yet another aspect of the invention, an article is provided in a computer-readable signal-bearing medium. Means in the medium are provided for managing a queue in a storage area network of an asynchronous messaging and queuing system. Means in the medium are provided for receiving a message request at a queue manager of a storage area network, and for passing the message request to a storage area network controller of the storage area network. The controller includes control means for controlling a transactional or persistent message.

In a further aspect of the invention, an asynchronous message-and-queue system is provided with a storage area network having a controller to manage a queue in the storage area network. The storage area network controller includes means to control a transactional or persistent message.

In an even further aspect of the invention, a method is provided for controlling messaging. A queue in a storage area network of an asynchronous messaging and queuing system is managed, and a transactional or persistent message is controlled.

In yet a further aspect of the invention, an article is provided in a computer-readable signal-bearing medium. Means in the medium are provided for managing a queue in a storage area network of an asynchronous messaging and queuing system. In addition, means in the medium are provided for controlling a transactional or persistent message in the queue.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram representing the component parts of a system according to a preferred embodiment of the present invention, and is suggested for printing on the first page of the issued patent.

FIG. 2 is illustrative of the load-balancing capability of a system according to a preferred embodiment of the present invention.

### DESCRIPTION OF THE PREFERRED EMBODIMENT

### Overview

A storage area network (SAN) is used to centralize and control message data and to eliminate a single point of failure in the message system. The SAN is a high speed network, comparable to a LAN, that allows the establishment of direct connections between storage devices and processors. The SAN can be viewed as an extension to the storage bus concept that enables storage devices and servers to be interconnected using similar elements as in local area networks and wide area networks. A SAN can be shared between servers and/or dedicated to one server. It can be local or can be extended over geographical distances. With implementation of the SAN, storage of messages are removed from individual servers and instead stored at the network level. The queue is also moved to the SAN and ownership of the queue is removed from the queue manager and is vested with a SAN controller. Queue managers can access and manipulate messages on the queue as they would a locally owned queue, but the underlying management of the manipulation is maintained within the SAN controller which provides primitives to control locking and transactional integrity for the messages on the queue(s) it owns.

### Technical Details

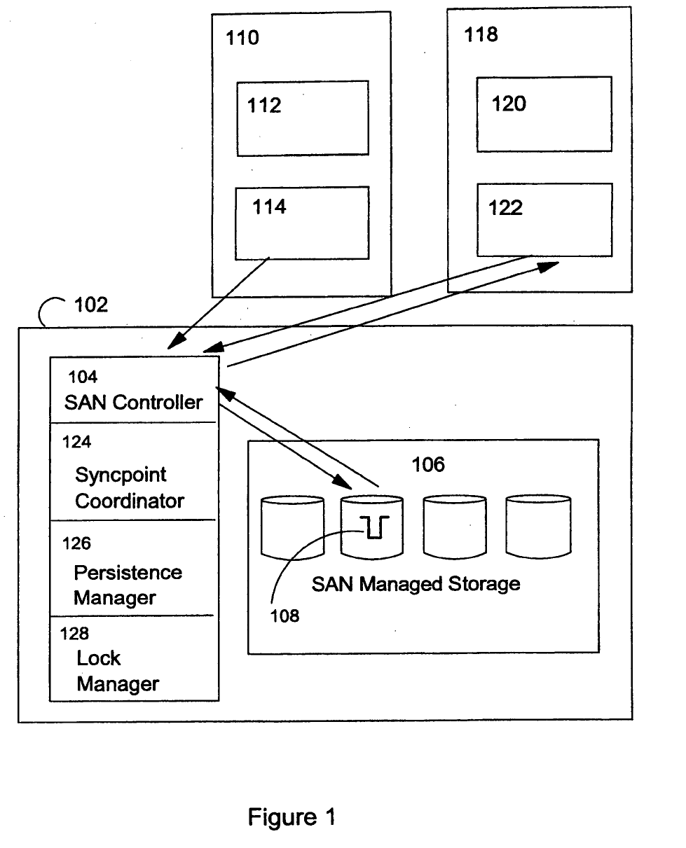

Turning now to FIG. 1, there are three main components of presently preferred embodiments of this invention which interact. The first is the SAN (102), controlled by the SAN controller (104). The second is the queue manager (114), which is writing the message to a queue (108) held in the SAN. The third is a queue manager (122), looking to read that message from the SAN held queue (108). Each queue manager (114, 122) is acting on behalf of an application (112, 120) that is making requests that must be satisfied by the queue manager (114, 122). The queue managers (114, 122) and the requesting applications (112, 120) may be located anywhere in a network. That is, systems or system components (110, 118) can be regions or partitions within a system, separate physical computer systems, distributed systems in a network, or any other combination of systems or system components.

In particular, to invoke any queue manager service, an application (112, 120) first requires a connection to the queue manager (114, 122). Thus the application (112, 120) first issues a call requesting a connection with the queue manager (114, 122), and, in response to this call, the queue manager returns a connection handle identifying the connection to be used by the application. The application (112, 120) will then pass this connection handle as an input parameter when making other calls for the duration of the connection. The application (112, 120) also requires an object handle for each object, such as a queue (108), to be used in performance of the required service. Thus, the application (112, 120) will submit one or more calls requesting object handles for each object to be used, and appropriate object handles will be dispensed by the queue manager (114, 122). All object handles supplied by the queue manager (114, 122) are associated with a particular connection handle, a given object handle being supplied for use by a particular connection, and hence for use together with the associated connection handle. After receiving the resources to be used, the application (112, 120) can issue a service request call requesting performance of a service. This call will include the connection handle and the object handle for each object to be used. In the case of retrieving a message from a queue (108), for example, the application issues a “get message” call including its connection handle and the appropriate queue handle dispensed to the application to identify the connection and queue (108) to the queue manager (114, 122).

Preferably, the SAN controller (104) of the preferred embodiment of the present invention is provided with a syncpoint coordinator (124), a persistence manager (126) and a lock manager (128). This enables centralization of functions that would otherwise be devolved out to the queue managers, leading to potential problems that may arise in conventional messaging-and-queuing systems.

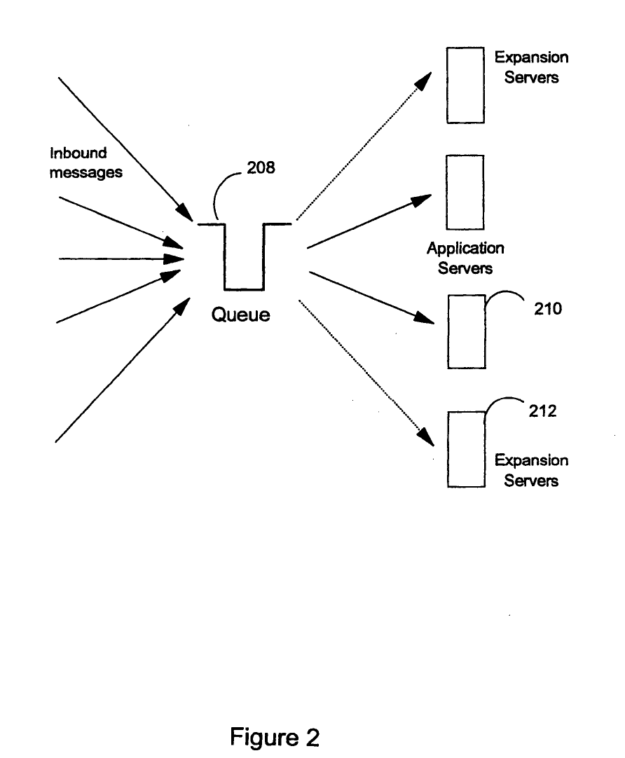

The preferred embodiment of the present invention is a highly suitable architecture for high throughput systems, with no chance of messages becoming “trapped” in a failed server, and the application throughput can also be “scaled up” by simply connecting more servers to the SAN. Conversely, if demand for the application falls, servers can be disconnected and the maximum possible throughput reduced, on a dynamic basic. As shown in FIG. 2, if demand for processing messages in queue (208) rises beyond the capacity of one or more application servers (210), one or more expansion servers (212) can be connected to the SAN, and thus added to the available processing resource available.

Below are described the interactions that may be provided in a presently preferred embodiment of the invention.

Interaction 1—Connection

| | |
|---|---|
| 100 | Queue Manager sends connection request to SAN Controller |
| 105 | SAN Controller accepts connection request |
| 110 | SAN Controller verifies identity of Queue Manager |
| 115 | If identity confirmed, SAN Controller confirms connection request, |
| | else refuses connection |

Interaction 2—Defining a Queue

| | |
|---|---|
| 200 | Administrator sends a request to define a queue on the SAN |
| 205 | SAN Controller validates and if appropriate, accepts request |
| 210 | SAN Controller allocates space for the queue on managed storage |
| 215 | SAN Controller builds necessary control structures |
| 220 | SAN Controller confirms completion of queue creation |

Interaction 3—Opening a Handle to a Queue

| | |
|---|---|
| 300 | Queue Manager sends request to open a handle to a queue |
| 305 | SAN Controller confirms existence of queue and authority to open |
| | handle 310 If queue does not exist or incorrect authority, |
| | fail the request |
| 315 | SAN Controller opens and returns handle to requesting queue |
| | manager |
| 320 | SAN Controller updates a usage counter for the queue |

Interaction 4—Placing a Message on the Queue

| | |
|---|---|
| 400 | Queue Manager sends a message to place on a queue |
| 405 | SAN Controller verifies authority to place message on queue. |
| 410 | SAN Controller writes message data into allocated, managed |
| | storage |
| 415 | SAN Controller checks if write is part of syncpoint |
| 420 | If part of syncpoint, SAN Controller places lock on message, |
| | confirms to application |
| 425 | If not in syncpoint, SAN Controller confirms message written to |
| | queue |

Interaction 5—Confirming Syncpoint (Simplified) (Read and Write Operations)

| | |
|---|---|
| 500 | Queue Manager sends syncpoint confirmation to SAN Controller |
| 505 | SAN Controller confirms queue operation (read or write) |
| 510 | SAN Controller clears lock on message, and removes message |
| | from queue if read operation |

Interaction 6—Backing Out Syncpoint (Simplified) (Read and Write Operations)

| | |
|---|---|
| 600 | Queue Manager sends syncpoint back out to SAN Controller |
| 605 | SAN Controller confirms queue operation backed out |
| | (read or write) |
| 610 | SAN Controller clears lock on message, and removes message |
| | from queue if write operation. |

Note that any syncpoint operations would typically be of the two phase commit type, but this level of detail is not needed in the present description. Between the SAN Controller and an attached queue manager, a full two phase commit may not be necessary.

Interaction 7—Reading a Message from a Queue

| | |
|---|---|
| 700 | Queue Manager sends a read request message to SAN Controller |
| 705 | SAN Controller checks if request is for specific message. If so, |
| | Interaction 8 - Reading a specific message |
| 710 | SAN Controller determines next available message to be read |
| 715 | If not a browse, SAN Controller locks message, and checks if read |
| | is under syncpoint |
| 720 | SAN Controller sends message and marks syncpoint if needed |
| 725 | If read is not a browse and out of syncpoint, message is removed |
| | from managed storage |

Interaction 8—Reading a Specific Message from a Queue

| | |
|---|---|
| 800 | SAN Controller checks if message exists and is not locked by |
| | other queue manager |
| 805 | If message is locked or does not exist, read request is rejected |
| 810 | If not a browse, SAN Controller locks message, and checks if |
| | read is under syncpoint |
| 815 | SAN Controller sends message and marks syncpoint if needed |
| 820 | If read is not a browse and out of syncpoint, message is removed |
| | from managed storage |

Interaction 9—Closing a Handle to a Queue

| | |
|---|---|
| 900 | Queue Manager sends request to close queue handle |
| 905 | SAN Controller verifies request and decrements usage counter |
| 910 | SAN Controller checks the usage counter for the queue |
| 912 | SAN Controller checks for any uncommitted syncpoints, |
| | and if found, rejects close handle request |
| 915 | If usage count is 0, SAN Controller deletes queue handle |
| 920 | If usage count is not 0, SAN Controller rejects close request |

Interaction 10—Deleting a Queue

| | |
|---|---|
| 1000 | Administrator sends request to delete queue |
| 1005 | If request is a “force delete” then delete queue and free |
| | allocated managed storage |
| 1015 | SAN Controller verifies that no messages are locked under |
| | syncpoint |
| 1020 | SAN Controller verifies that no other queue managers have open |
| | handles 1025 If above tests are true, then delete queue and |
| | free allocated managed storage |
| 1030 | If any tests above are false, then reject close request. |

Interaction 11—Listing Owned Queues

| | |
|---|---|
| 1100 | Queue manager or system management API sends request to list |
| | owned queues |
| 1105 | SAN Controller sends details |

Interaction 12—Amending Queue Definition

| | |
|---|---|
| 1200 | Queue manager or system management API sends request to |
| | amend queue definition |
| 1205 | SAN Controller verifies request possible and executes changes. |

Interaction 13—Queue Manager Health Check

| | |
|---|---|
| 1300 | SAN Controller sends health check to each connected |
| | queue manager |
| 1305 | If no response from health check, SAN Controller disconnects |
| | failed queue manager |

Interaction 14—Disconnect Failed Queue Manager

| | |
|---|---|
| 1400 | SAN Controller terminates each handle owned by the failed |
| | queue manager |
| 1405 | SAN Controller checks for all uncommitted syncpoints, and |
| | backs them out |
| 1410 | SAN Controller closes all open handles to queue |
| 1415 | SAN Controller closes connection handle to failed queue |
| | manager |
| 1420 | SAN Controller reports failure event |

Messages can have the property of being persistent or they can be non-persistent. A persistent message must be logged and journaled by the queue manager before any subsequent processing can occur, and a non-persistent message is discarded in the event of a queue manager failure. The centralization of messaging supported by the use of the SAN and SAN controller is particularly suitable for the control of queues where persistent messages may be placed.

### Advantages Over The Prior Art

By moving the storage of messages to a SAN, support infrastructure in the SAN may be used to supply all required data integrity and functionality to allow multiple queue managers to access the queue simultaneously for read and write operations. Other advantages include removal of messages, i.e. data, from the application server where instead of being accessible by one server, the messages are potentially accessible by any server which can connect to the SAN. An addition of locking and two phase commit primitives to the SAN controller allows multiple servers to connect to the SAN and to simultaneously access the messages on the queues for reads, writes, deletes, locks, and transactional operations, with the same level of data integrity that is offered by a single queue manager controlling multi-threaded access to a single queue. Another benefit is that it is possible to filter all messages inbound to a particular application to one queue maintained in the SAN. From there they can be distributed to any number of connected servers for subsequent processing by the application with complete transparency to the application. Finally, since all message data is centrally located, providing for backup and disaster recovery is simplified as all persistent data is located in one place, and base SAN services can be utilized to ensure that a secure copy is made.

### ALTERNATIVE EMBODIMENTS

It will be appreciated that, although specific embodiments of the invention have been described herein for purposes of illustration, various modifications may be made without departing from the spirit and scope of the invention. In particular, a set of protocols may be provided for data integrity, transactionality, and other qualities of service between the various components. In such a case, data integrity, syncpoint coordination, etc. would be conducted and controlled by a middleware layer, which would supply the appropriate set of primitives to the SAN controller and to the applications and queue managers. Accordingly, the scope of protection of this invention is limited only by the following claims and their equivalents.

1. (canceled)

2. (canceled)

3. (canceled)

4. (canceled)

5. (canceled)

6. (canceled)

7. (canceled)

8. (canceled)

9. (canceled)

10. (canceled)

11. A computer system comprising:
an asynchronous message and queue system;
a storage area network controller in communication with said asynchronous message and queue system;
said storage are network controller having control means adapted to control a message queue on behalf of a queue manager; and
said storage area network controller adapted to control a message selected from a group consisting of: transactional and persistent.

12. The system of claim 11, wherein said queue is adapted to support simultaneous access by a first queue manager and a second queue manager.

13. The system of claim 11, further comprising a connection handle adapted to be authorized by said controller and returned to a call request to connect an application with said queue manager.

14. The system of claim 13, further comprising a counter adapted to track a quantity of handles authorized for said queue.

15. The system of claim 13, further comprising an object handle adapted to be dispensed by said queue manager for use in performance of a service to an object.

16. The system of claim 15, wherein said object handle and said connection handle function as input parameters to a call request.

17. The system of claim 11, wherein said transactional message control is in the form of a syncpoint coordinator.

18. The system of claim 11, wherein said storage area network controller includes a lock manager adapted to preserve data integrity.

19. A method for communicating in a computer system comprising:
managing a queue in a storage area network of said computer system supporting an asynchronous messaging and queuing system;
receiving a message request at a queue manager of said storage area network; and
passing said received message request to a storage area network controller of said storage area network, wherein said controller includes means to control a message selected from a group consisting of: transactional and persistent.

20. The method of claim 19, further comprising supporting simultaneous access to said queue by a first queue manager and a second queue manager.

21. The method of claim 19, wherein the step of managing a queue in a storage area network includes authorizing a connection handle to a call request from said queue manager.

22. The method of claim 21, further comprising tracking a quantity of authorized connection handles for said queue.

23. The method of claim 21, wherein the step of managing a queue in a storage area network includes dispensing an object handle by said queue manager for performance of a service to an object.

24. The method of claim 19, wherein said transaction message control means utilizes a syncpoint coordinator.

25. The method of claim 19, wherein the step of managing a queue in a storage area network includes preserving data integrity.

26. An article comprising:
a computer-readable signal-bearing medium;
means in the medium for managing a queue in a storage area network of an asynchronous messaging and queuing system;
means in the medium for receiving a message request at a queue manager of a storage area network; and
means in the medium for passing said message request to a storage area network controller of said storage area network, wherein said controller includes means for controlling a message selected from a group consisting of: transactional and persistent.

27. The article of claim 26, further comprising means in the medium for supporting simultaneous access to said queue by a first queue manager and a second queue manager.

28. The article of claim 26, wherein said means for managing a queue in a storage area network includes means for authorizing a connection handle to a call request from said queue manager.

29. The article of claim 28, further comprising means in the medium for tracking a quantity of authorized connection handles for said queue.

30. The article of claim 28, wherein said means for managing a queue in a storage area network includes means for dispensing an object handle by one of said queue managers for performance of a service to an object.

31. The article of claim 26, wherein said transactional message control means includes a syncpoint coordinator.

32. The article of claim 26, wherein said means for managing a queue in a storage area network includes preserving data integrity.

33. An asynchronous message-and-queue system comprising:
a storage area network having a controller adapted to control a queue in said storage area network; and
said storage area network controller having means adapted to control a message selected from a group consisting of: transactional and persistent.

34. The system of claim 33, wherein said transactional message control means includes a syncpoint coordinator.

35. The system of claim 33, wherein said controller includes a lock manager adapted to preserve data integrity.

36. The system of claim 33, wherein controller includes a first queue manager and a second queue manager to manage said queue, and wherein said queue managers are heterogenous.

37. A method for messaging comprising:
managing a queue in a controller of a storage area network of an asynchronous messaging and queuing system; and
controlling a message in said queue, wherein said message is selected from a group consisting of: transactional and persistent.

38. The method of claim 37, wherein the step of controlling a transactional message includes a syncpoint coordinator.

39. The method of claim 37, wherein the step of managing a queue in a storage area network includes tracking a quantity of connection handles authorized for said queue.

40. An article comprising:
a computer-readable signal-bearing medium;
means in the medium for managing a queue in a storage area network of an asynchronous messaging and queuing system; and
means in the medium for controlling a message in said queue, wherein said messaging is selected from a group consisting of: transactional and persistent.
